(19) United States
(12) Patent Application Publication
(10) Pub. No.: US 2006/0033839 A1
(43) Pub. Date: Feb. 16, 2006

(54) DE-INTERLACING METHOD

(76) Inventor: Po-Wei Chao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/161,727

(22) Filed: Aug. 15, 2005

(30) Foreign Application Priority Data
Aug. 16, 2004 (TW) 093124576

(51) Int. Cl. H04N 11/20

(52) U.S. Cl. 348/448

(57) ABSTRACT

A method for de-interlacing video data to generate a pixel value of a target position in an output frame, wherein the video data has consecutive first, second, and third fields and the method includes: detecting a degree of difference between the first field and the second field with respect to the target position; detecting a degree of difference between the second field and the third field with respect to the target position; and generating the pixel value for the target position of the output frame according to the detected degree of difference between the first and second fields and the detected degree of difference between the second and third fields.

### BACKGROUND OF THE INVENTION

1. Field of the Invention

The present invention relates to a video processing method, and more particularly, to a de-interlacing method.

2. Description of the Prior Art

In conventional interlaced scanning, an odd field composed of odd scan lines and an even field composed of even scan lines of a frame are successively scanned.

Recently, progressive scan techniques, which are also referred to as non-interlaced scan, combine the odd field and the even field into one frame and then scan the frame using double horizontal scan frequency in sequence so that the quality of the display image is improved.

In order to display video data in progressive scan, a deinterlacing operation is required to interpolate a new scan line between two successive scan lines within a field.

### SUMMARY OF THE INVENTION

It is therefore an objective of the claimed invention to provide a motion adaptive deinterlacing method to improve image quality.

According to an exemplary embodiment of the present invention, a method for de-interlacing video data comprising consecutive first, second, and third fields to generate a pixel value of a target position in an output frame is disclosed. The method comprises: detecting a degree of difference between the first field and the second field with respect to the target position; detecting a degree of difference between the second field and the third field with respect to the target position; and generating the pixel value of the target position in the output frame according to the detected degree of difference between the first and second fields and the detected degree of difference between the second and third fields.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing video data including four consecutive fields and a corresponding output frame according to the present invention.

FIG. 2 is a block diagram of a deinterlacing apparatus according to one embodiment of the present invention.

FIG. 3 is a flowchart illustrating an operation of generating a pixel value for a target location of the output frame of FIG. 1 according to one embodiment of the present invention.

### DETAILED DESCRIPTION

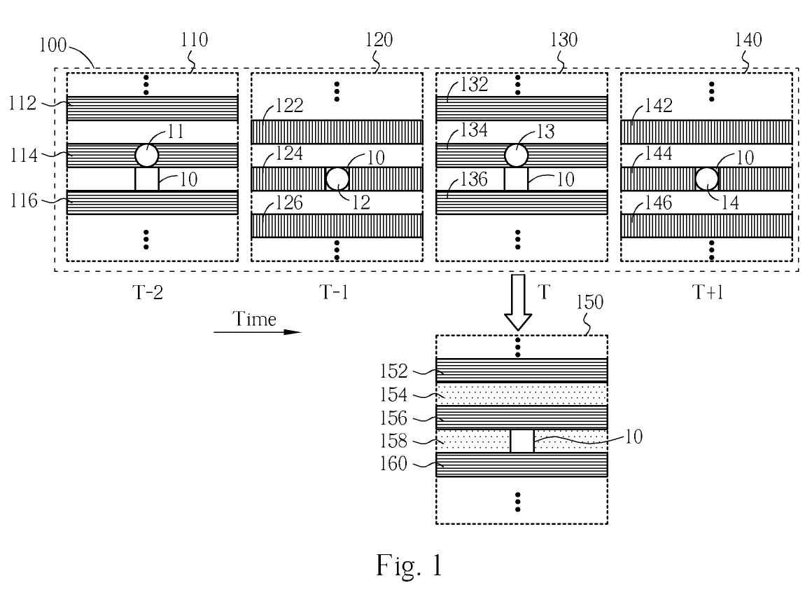

Please refer to FIG. 1, which depicts a diagram showing four consecutive fields of a video data 100 and a corresponding de-interlaced output frame 150 according to the present invention. The output frame 150 corresponds to time T while the four consecutive fields 110, 120, 130 and 140 correspond to times T−2, T−1, T and T+1, respectively. In FIG. 1, scan lines 112, 122, 132 and 142 are respectively the (N−1)th scan lines of fields 110, 120, 130 and 140; scan lines 114, 124, 134 and 144 are respectively the Nth scan lines of fields 110, 120, 130 and 140; and scan lines 116, 126, 136 and 146 are respectively the (N+1)th scan lines of fields 110, 120, 130 and 140.

In this embodiment, the output frame 150 is de-interlaced from the video data 100 on a pixel-by-pixel basis. In other words, the de-interlacing method of the present invention is a motion adaptive de-interlacing method. In this way, the de-interlacing operation of a respective pixel is based on the image features of the pixel so that optimal image quality can be obtained.

In general, pixel values of the scan lines 132, 134 and 136 of the field 130 corresponding to time T could be used for pixel values at same pixel locations of the scan lines 152, 156 and 160 in the output frame 150, which also corresponds to time T, but the present invention does not intend to be limited to above fashion. Pixel values of the scan lines 154 and 158 in the output frame 150 are typically created by de-interlacing operations. The following embodiments illustrate the method and apparatus for generating pixel value for a target position 10 of the output frame 150 in accordance with the present invention.

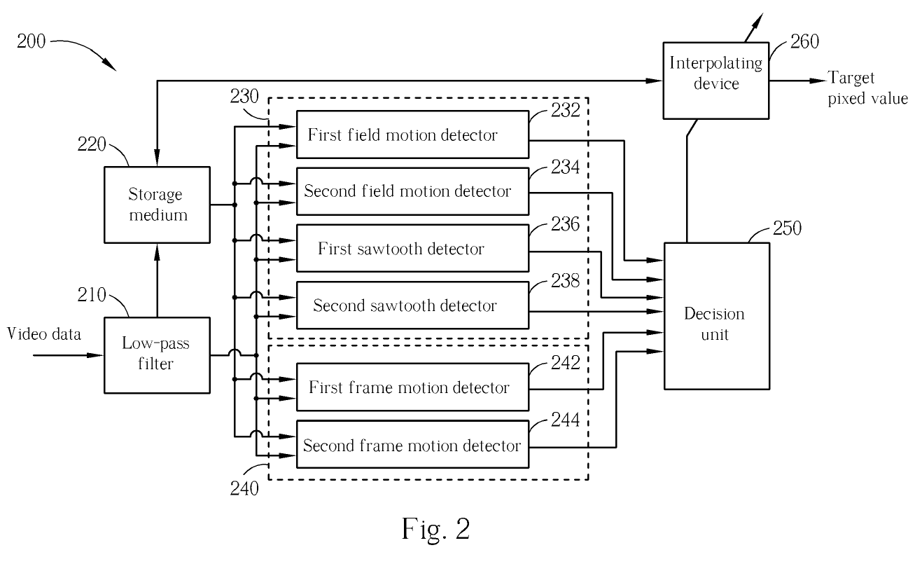

Please refer to FIG. 2, which depicts a block diagram of a de-interlacing apparatus 200 according to one embodiment of the present invention. As shown, the de-interlacing apparatus 200 comprises a low-pass filter 210, a storage medium 220, an inter-field difference detector 230, an inter-frame difference detector 240, a decision unit 250 and an interpolating device 260. In this embodiment, the low-pass filter 210 is used for low-pass filtering the video data 100 to smooth images. In practice, the video data 100 could be directly input into the following stages without the low-pass filtering process. The storage medium 220 is used for temporarily storing required pixel data during the de-interlacing operation. The storage medium 220 could be implemented with a buffer or a memory. The inter-field difference detector 230 is used for determining the degree of difference between two successive fields (e.g., between the current field 130 and the previous field 120 and/or between the current field 130 and the next field 140) with respect to the target position 10. The inter-frame difference detector 240 is used for determining the degree of difference between two successive frames (e.g., between the field 140 and the field 120 and/or between the current field 130 and the field 110). The decision unit 250 could selectively rely on the results of the inter-field difference detector 230 and/or the inter-frame difference detector 240 to control the interpolating device 260 to generate the pixel value of the target position 10 in the frame 150 by using a corresponding interpolating operation such as an inter-field interpolation or an intra-field interpolation.

In this embodiment, the inter-field difference detector 230 comprises a first field motion detector 232, a second field motion detector 234, a first sawtooth detector 236 and a second sawtooth detector 238. The first field motion detector 232 is used for determining the degree of difference between the current field 130 and the previous field 120 with respect to the target position 10. In this embodiment, a sum of absolute differences (SAD) of a plurality of pixels in the corresponding locations within the two fields could be used to represent the degree of difference. For example, this difference could be represented with the SAD between a first pixel set composed of pixel 13 corresponding to the target position 10 and surrounding pixels (e.g., the neighboring pixels to the left or right of the pixel 13) within the field 130 and a second pixel set composed of pixel 12 corresponding to the target position 10 and surrounding pixels (e.g., the neighboring pixels to the left or right of the pixel 12) within the field 120. Of course, those of ordinary skill in the art could use other measurement values to represent the degree of difference between two fields and not be restricted to the above example.

The second field motion detector 234 is used for determining the degree of difference between the current field 130 and the next field 140 with respect to the target position 10. Similarly, this difference could be represented with SAD between pixels or other measurement value. The first sawtooth detector 236 is used for determining the degree of sawtooth artifact between the current field 130 and the previous field 120 with respect to the target position 10 while the second sawtooth detector 238 is used for determining the degree of sawtooth artifact between the current field 130 and the next field 140 with respect to the target position 10. Those of ordinary skill in the art will realize that the degree of sawtooth artifact can be regarded as a degree of difference and could also be represented with SAD between pixels or other measurement values.

In this embodiment, the inter-frame difference detector 240 comprises a first frame motion detector 242 and a second frame motion detector 244. The first frame motion detector 242 is used for determining the degree of difference between the next field 140 and the previous field 120 with respect to the target position 10. The second frame motion detector 244 is used for determining the degree of difference between the current field 130 and the field 110 with respect to the target position 10. As is well known in the art, the difference could also be represented with SAD value or other measurement values and therefore further details are omitted here.

Please note that although the shown de-interlacing apparatus 200 of the above embodiment has two field motion detectors, two sawtooth detectors and two frame motion detectors, in practice, the decision unit 250 could control the interpolating device 260 based only on a portion of the detection results obtained by the above detectors instead of all the detection results. Accordingly, some detectors may be omitted in other embodiments. In addition, the above-mentioned detectors (i.e., the field motion detectors, the frame motion detectors, and the sawtooth detectors) with different functional blocks could be implemented within the same integrated circuit.

Furthermore, the respective pixel sets employed in the above-mentioned detectors could be selected based on a same selecting rule or different rules. In other words, the pixel sets employed in those detectors could be the same or different.

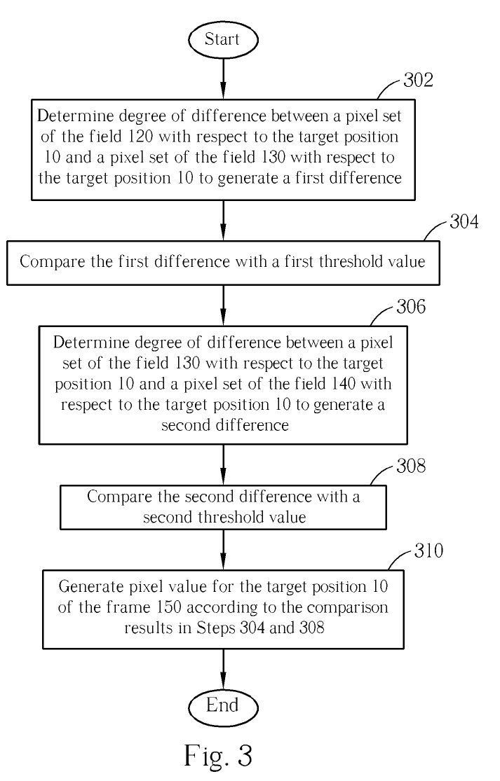

FIG. 3 shows a flowchart 300 illustrating how the de-interlacing apparatus 200 generates pixel values of the target position 10 in the output frame 150 according to one embodiment of the present invention. The steps of the flowchart 300 are described as follows:

Step 302: The inter-field difference detector 230 determines the degree of difference between a pixel set of the field 120 with respect to the target position 10 and a pixel set of the field 130 with respect to the target position 10 to generate a first difference PD1.

Step 304: Compare the first difference PD1 with a first threshold value TH1.

Step 306: The inter-field difference detector 230 determines the degree of difference between a pixel set of the field 130 with respect to the target position 10 and a pixel set of the field 140 with respect to the target position 10 to generate a second difference PD2.

Step 308: Compare the second difference PD2 with a second threshold value TH2.

Step 310: The decision unit 250 controls the interpolating device 260 to generate the pixel value for the target position 10 of the frame 150 using pixel values of pixels of the field 120, the field 130 and/or the field 140 according to the comparison results in Steps 304 and 308.

In implementations, Steps 304 and 308 could be performed by the inter-field difference detector 230 or by the decision unit 250.

The order of above Steps 302 through 308 is only an exemplary embodiment of the present invention, and does not restrict the implementations of the present invention. For convenience of description, Step 302 is herein assumed to be performed by the first field motion detector 232 while Step 306 is assumed to be performed by the second field motion detector 234.

In Step 310, the decision unit 250 generates a control signal according to the results of Steps 304 and 308 so as to control the operation of the interpolating device 260. For example, if the first difference PD1 is less than the first threshold value TH1 while the second difference PD2 is greater than the second threshold value TH2, the decision unit 250 determines that there is no field motion between the pixel set corresponding to the target position 10 of the field 130 and the pixel set corresponding to the target position 10 of the field 120, but it determines that there is field motion between the pixel set corresponding to the target position 10 of the field 130 and the pixel set corresponding to the target position 10 of the field 140. Accordingly, the decision unit 250 controls the interpolating device 260 to generate a pixel value for the target position 10 of the frame 150 based on pixel values of pixels corresponding to the target position 10 of the previous field 120. In one embodiment, the interpolating device 260 could directly use a pixel value of the pixel 12 corresponding to the target position 10 of the field 120 as the pixel value of the target position 10 of the frame 150.

On the contrary, if the first difference PD1 is greater than the first threshold value TH1 while the second difference PD2 is less than the second threshold value TH2, the decision unit 250 determines that there is field motion between the pixel set corresponding to the target position 10 of the field 130 and the pixel set corresponding to the target position 10 of the field 120, but it determines that there is no field motion between the pixel set corresponding to the target position 10 of the field 130 and the pixel set corresponding to the target position 10 of the field 140. Accordingly, under the circumstances, the decision unit 250 controls the interpolating device 260 to generate a pixel value for the target position 10 of the frame 150 based on pixel values of pixels corresponding to the target position 10 of the next field 140. For example, in one embodiment, the interpolating device 260 could directly use a pixel value of the pixel 14 corresponding to the target position 10 of the field 140 as the pixel value of the target position 10 of the frame 150.

Another situation is that the first difference PD1 is greater than the first threshold value TH1 and the second difference PD2 is also greater than the second threshold value TH2. Accordingly, the decision unit 250 determines that there is field motion between the pixel set of the field 130 and the pixel set of the field 120 and also determines that there is field motion between the pixel set of the field 130 and the pixel set of the field 140. Under the circumstances, the interpolating device 260 performs an intra-field interpolation to generate a pixel value for the target position 10 of the frame 150 using the existing pixels of the field 130 under the control of the decision circuit 250. In practice, the intra-field interpolation could be accomplished with various implementations, and the present invention is not limited to any specific interpolation algorithms and methods.

Additionally, if the first difference PD1 is less than the first threshold value TH1 while the second difference PD2 is also less than the second threshold value TH2, then the decision unit 250 determines that there is no field motion between the pixel set of the field 130 and the pixel set of the field 120 and also determines that there is no field motion between the pixel set of the field 130 and the pixel set of the field 140. Under the circumstances, the image surrounding the target position 10 in the fields 120, 130 and 140 would be regarded (or classified) as a still object. Therefore, the interpolating device 260 could generate a pixel value for the target position 10 of the frame 150 by referring pixel values of pixels corresponding to the target position 10 of either the field 120 or the field 140, or by referring pixel values of pixels corresponding to the target position 10 of both the fields 120 and 140. In other words, the interpolating device 260 performs an inter-field interpolation to generate the pixel value for the target position 10 of the frame 150.

In the aforementioned embodiment, the field motion detectors 232 and 234 are employed to perform Steps 302 and 306 respectively. In implementations, Steps 302 and 306 could be performed by the first sawtooth detector 236 and the second sawtooth detector 238 respectively, instead of the two field motion detectors 232 and 234. In this situation, the first sawtooth detector 236 and the second sawtooth detector 238 are used for determining if there is sawtooth artifact between pixel sets of the current field 130 and pixel sets of the previous field 120 or between pixel sets of the current field 130 and pixel sets of the next field 140. The determined results are then used for controlling the operation of the interpolating device 260. The control scheme is substantially the same as the previously mentioned description and further details are therefore omitted here. Those of ordinary skill in the art will understand that the field motion detection and the sawtooth detection could be integrated in the Steps 302 and 306. For example, in one embodiment, the first field motion detector 232 is employed to perform Step 302 while the second sawtooth detector 238 is employed to perform Step 306. In another embodiment, the first sawtooth detector 236 is employed to perform Step 302 while the second field motion detector 234 is employed to perform Step 306. In addition to the above embodiments, it is performable that both the first field motion detector 232 and the first sawtooth detector 236 are employed to perform Step 302, while both the second field motion detector 234 and the second sawtooth detector 238 are employed to perform Step 306.

In order to improve the image quality of de-interlaced frame, the de-interlacing apparatus 200 could further evaluate the detection results of the inter-frame difference detector 240 to control the operation of the interpolating device 260. In one embodiment, for example, the first frame motion detector 242 determines the degree of difference between a pixel set of the field 140 with respect to the target position 10 and a pixel set of the field 120 with respect to the target position 10 to generate a fifth difference PD5. The first frame motion detector 242 then compares the fifth difference PD5 with a fifth threshold value TH5. In this embodiment, the decision unit 250 evaluates this comparison result and the above-mentioned detection results to control the interpolating device 260.

In this embodiment, if the first difference PD1 is less than the first threshold value TH1 while the second difference PD2 is greater than the second threshold value TH2, the decision unit 250 determines that there is no field motion between the pixel set corresponding to the target position 10 of the field 130 and the corresponding pixel set of the field 120, but it determines that there is field motion between the pixel set corresponding to the target position 10 of the field 130 and the corresponding pixel set of the field 140. In this situation, if the fifth difference PD5 is greater than the fifth threshold value TH5, the decision unit 250 determines that there is frame motion between the pixel set corresponding to the target position 10 of the field 120 and the corresponding pixel set of the field 140. It is obvious that the detection result of the inter-frame difference detector 240 matches the detection result of the inter-field difference detector 230. Accordingly, the decision unit 250 controls the interpolating device 260 to generate the pixel value for the target position 10 of the frame 150 according to the values of the pixels corresponding to the target position 10 of the field 120. On the other hand, if the fifth difference PD5 is less than the fifth threshold value TH5, the decision unit 250 determines that there is no frame motion between the pixel set corresponding to the target position 10 of the field 120 and the corresponding pixel set of the field 140. Since the detection result of the inter-frame difference detector 240 conflicts with the detection result of the inter-field difference detector 230, the decision unit 250 controls the interpolating device 260 to perform an intra-field interpolation so as to generate the pixel value for the target position 10 of the frame 150 according to the values of the existing pixels of the field 130.

If the first difference PD1 is greater than the first threshold value TH1 while the second difference PD2 is less than the second threshold value TH2, it represents that there is field motion between the pixel set corresponding to the target position 10 of the field 130 and the corresponding pixel set of the field 120, but no field motion between the pixel set corresponding to the target position 10 of the field 130 and the corresponding pixel set of the field 140. In this situation, if the fifth difference PD5 is greater than the fifth threshold value TH5, then the detection result of the inter-frame difference detector 240 matches the detection result of the inter-field difference detector 230. Therefore, the decision unit 250 controls the interpolating device 260 to generate the pixel value for the target position 10 of the frame 150 according to the values of the pixels corresponding to the target position 10 of the field 140. Conversely, if the fifth difference PD5 is less than the fifth threshold value TH5, then the detection result of the inter-frame difference detector 240 conflicts with the detection result of the inter-field difference detector 230. Consequently, the decision unit 250 controls the interpolating device 260 to perform an intra-field interpolation so as to generate the pixel value for the target position 10 of the frame 150 according to the values of the existing pixels of the field 130.

In other words, in this embodiment, the interpolating device 260 generates the pixel value for the target position 10 of the frame 150 according to the value of the pixels corresponding to the target position 10 of the field 120 or 140 only when the detection result of the inter-frame difference detector 240 matches the detection result of the inter-field difference detector 230. When the detection result of the inter-frame difference detector 240 conflicts with the detection result of the inter-field difference detector 230, the interpolating device 260 directly performs an intra-field interpolation to generate the pixel value for the target position 10 of the frame 150 based on the existing pixels of the field 130. Thus, the present invention is capable of preventing the pixel value of the target position 10 of the frame 150 from being interpolated based on values of improper pixels of the previous field or the next field. The resulting image quality of the de-interlaced frame is thereby improved.

In another embodiment, the second frame motion detector 244 further determines the degree of difference between a pixel set corresponding to the target position 10 of the field 130 and a pixel set corresponding to the target position 10 of the field 110 to generate a sixth difference PD6. The second frame motion detector 244 then compares the sixth difference PD6 with a sixth threshold value TH6. In this embodiment, the decision unit 250 further evaluates the comparison result so as to control the interpolating device 260.

Specifically, when the first difference PD1 is greater than the first threshold value TH1, the second difference PD2 is greater than the second threshold value TH2, the fifth difference PD5 is less than the fifth threshold value TH5, and the sixth difference PD6 is less than the sixth threshold value TH6, these detection results are interpreted as there not only being a still image surrounding the target position 10 of the fields 110, 120, 130 and 140, but also the appearance of a horizontal still line, which only presents in either the odd or the even field. Under this situation, the decision unit 250 controls the interpolating device 260 to generate the pixel value for the target position 10 of the frame 150 according to the values of the pixels corresponding to the target position 10 of either the field 120 or the field 140 instead of both. In another embodiment, in addition to the above conditions, it is also required that the difference between the first difference PD1 and the second difference PD2 is less than a predetermined threshold so that the decision unit 250 determines the existence of a horizontal still line.

As described above, in the de-interlacing method of the present invention, more than one pixel detection could be concurrently employed in Step 302 or 306. For example, in Step 302, the de-interlacing apparatus 200 could utilize the first field motion detector 232 to determine the degree of difference between a pixel set of the field 130 and a corresponding pixel set of the field 120 so as to generate a first difference PD1, and also utilize the first sawtooth detector 236 to determine the degree of difference between a pixel set corresponding to the target position 10 of the field 130 and a pixel set corresponding to the target position 10 of the field 120 so as to generate a third difference PD3. In Step 304, the decision unit 250 is then employed to determine if there is field motion between the field 130 and the field 120 by comparing the first difference PD1 with a first threshold value TH1 and to determine if there is sawtooth artifact by comparing the third difference PD3 with a third threshold value TH3.

In Step 306, the de-interlacing apparatus 200 could utilize the second field motion detector 234 to determine the degree of difference between a pixel set of the field 130 and a corresponding pixel set of the field 140 so as to generate a second difference PD2, and could also utilize the second sawtooth detector 238 to determine the degree of difference between a pixel set corresponding to the target position 10 of the field 130 and a pixel set corresponding to the target position 10 of the field 140 in order to generate a fourth difference PD4. Afterwards, in Step 304, the decision unit 250 is then employed to determine if there is field motion between the field 130 and the field 140 by comparing the second difference PD2 with a second threshold value TH2, and to determine if there is sawtooth artifact by comparing the fourth difference PD4 with a fourth threshold value TH4.

In this embodiment, the interpolating device 260 is allowed to use the values of the pixels corresponding to the target position 10 of the field 120 to generate the pixel value for the target position 10 of the frame 150 only when there is no field motion between the field 120 and the field 130 with respect to the target position 10, and no sawtooth artifact presents in the fields 120 and 130 with respect to the target position 10. Similarly, the interpolating device 260 is allowed to use the values of the pixels corresponding to the target position 10 of the field 140 to generate the pixel value for the target position 10 of the frame 150 only when there is no field motion between the field 140 and the field 130 with respect to the target position 10, and no sawtooth artifact in the fields 140 and 130 with respect to the target position 10. If the determining result of Step 310 is that the interpolating device 260 is not allowed to use the values of the pixels of the fields 120 and 140, the interpolating device 260 performs an intra-field interpolation to generate the pixel value for the target position 10 of the frame 150 according to the existing pixels of the field 130. In this way, the present invention is capable of preventing the pixel value of the target position 10 of the frame 150 from being interpolated using improper pixels of the previous field or the next field.

As mentioned above, the de-interlacing apparatus 200 could utilize the first frame motion detector 242 to determine the degree of difference between a pixel set corresponding to the target position 10 of the field 120 and a pixel set corresponding to the target position 10 of the field 140 to generate a fifth difference PD5. Therefore, the decision unit 250 could verify the detection result of the inter-field difference detector 230 according to the comparison between the fifth difference PD5 and a fifth threshold value TH5.

Similarly, the de-interlacing apparatus 200 could further utilize the second frame motion detector 244 to determine the degree of difference between a pixel set corresponding to the target position 10 of the field 130 and a pixel set corresponding to the target position 10 of the field 110 to compute a sixth difference PD6. According to the comparison between the sixth difference PD6 and a sixth threshold value TH6, and other detection results described above, the decision unit 250 can accordingly determine if a horizontal still line, which only presents in either the odd field or the even field, appears in the image surrounding the target position 10 in the fields 110, 120, 130 and 140. For example, when the first difference PD1 is greater than the first threshold value TH1, the second difference PD2 is greater than the second threshold value TH2, the third difference PD3 is greater than the third threshold value TH3, the fourth difference PD4 is greater than the fourth threshold value TH4, the fifth difference PD5 is less than the fifth threshold value TH5, and the sixth difference PD6 is less than the sixth threshold value TH6, it represents that a horizontal still line, which only presents in either the odd field or the even field, appears in the image of the fields 110, 120, 130 and 140 with respect to the target position 10. Accordingly, the decision unit 250 controls the interpolating device 260 to generate the pixel value for the target position 10 of the frame 150 according to the values of the pixels corresponding to the target position 10 of either the field 120 or the field 140 instead of both.

In another embodiment, the decision unit 250 determines that a horizontal still line, which only presents in either the odd field or the even field, appears in the image of the fields 110, 120, 130 and 140 with respect to the target position 10 only when the first difference PD1 is greater than the first threshold value TH1, the second difference PD2 is greater than the second threshold value TH2, the third difference PD3 is greater than the third threshold value TH3, the fourth difference PD4 is greater than the fourth threshold value TH4, the fifth difference PD5 is less than the fifth threshold value TH5, the sixth difference PD6 is less than the sixth threshold value TH6, the difference between the first difference PD1 and the second difference PD2 is less than a seventh threshold value TH7, and the difference between the third difference PD3 and the fourth difference PD4 is less than an eighth threshold value TH8.

As in the previously mentioned illustration, the present invention de-interlacing method generates pixels for the frame 150 on a pixel-by-pixel basis, i.e., the corresponding de-interlacing operation of a specific image area is decided based on the image features of the specific image area. In addition, the present invention de-interlacing method is capable of generating the pixel value for the target position 10 of the frame 150 based on only the values of the pixels of one of the previous field or the next field. Therefore, the disclosed de-interlacing method of the present invention could be applied to the interlaced video data of both the NTSC format and the PAL format.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for de-interlacing video data to generate a pixel value of a target position in an output frame, the video data comprising consecutive first, second, and third fields, the method comprising:
detecting a degree of difference between the first field and the second field with respect to the target position;
detecting a degree of difference between the second field and the third field with respect to the target position; and
generating the pixel value of the target position in the output frame according to the detected degree of difference between the first and second fields and the detected degree of difference between the second and third fields.

2. The method of claim 1, wherein the step of detecting the degree of difference between the first field and the second field further comprises:
detecting pixel differences between a first pixel set corresponding to the target position of the first field and a second pixel set corresponding to the target position of the second field to determine a first difference value.

3. The method of claim 2, wherein the step of detecting the degree of difference between the first field and the second field further comprises:
comparing the first difference value with a first threshold value.

4. The method of claim 1, wherein the step of detecting the degree of difference between the second field and the third field further comprises:
detecting pixel differences between a second pixel set corresponding to the target position of the second field and a third pixel set corresponding to the target position of the third field to determine a second difference value.

5. The method of claim 4, wherein the step of detecting the degree of difference between the second field and the third field further comprises:
comparing the second difference value with a second threshold value.

6. The method of claim 1, wherein the step of detecting the degree of difference between the first field and the second field further comprises:
determining if there is field motion between the first field and the second field.

7. The method of claim 1, wherein the step of detecting the degree of difference between the first field and the second field further comprises:
determining if there is sawtooth artifact between the first field and the second field.

8. The method of claim 1, wherein the step of detecting the degree of difference between the second field and the third field further comprises:
determining if there is field motion between the second field and the third field.

9. The method of claim 1, wherein the step of detecting the degree of difference between the second field and the third field further comprises:
determining if there is sawtooth artifact between the second field and the third field.

10. The method of claim 1, wherein both the step of detecting the degree of difference between the first field and the second field and the step of detecting the degree of difference between the second field and the third field further comprises:
calculating a sum of absolute differences (SAD) of a plurality of pixel values.

11. The method of claim 1, further comprising:
detecting a degree of difference between the first field and the third field with respect to the target position.

12. The method of claim 11, further comprising:
generating the pixel value of the target position in the output frame according to the detected degree of difference between the first and second fields, the detected degree of difference between the second and third fields, and the detected degree of difference between the first and third fields.

13. The method of claim 11, wherein the step of detecting the degree of difference between the first field and the third field further comprises:
determining if there is frame motion between a first frame to which the first field belongs and a third frame to which the third field belongs.

14. The method of claim 11, wherein the video data further comprises a fourth field prior to the first field, and the method further comprises:
detecting a degree of difference between the second field and the fourth field with respect to the target position.

15. The method of claim 14, further comprising:
generating the pixel value of the target position in the output frame according to the detected degree of difference between the first and second fields, the detected degree of difference between the second and third fields, the detected degree of difference between the first and third fields, and the detected degree of difference between the second and fourth fields.

16. The method of claim 14, wherein the step of detecting the degree of difference between the second field and the fourth field further comprises:
determining if there is frame motion between a second frame to which the second field belongs and a fourth frame to which the fourth field belongs.

17. The method of claim 14, further comprising:
determining if a horizontal still line presents in the video data according to the detected degree of difference between the first and second fields, the detected degree of difference between the second and third fields, the detected degree of difference between the first and third fields, and the detected degree of difference between the second and fourth fields.

18. The method of claim 1, further comprising:
low-pass filtering the video data.

19. The method of claim 1, wherein the step of generating the pixel value for the target position of the output frame further comprises:
calculating the pixel value of the target position in the output frame according to pixel values of the first field and pixel values of the third field.

20. The method of claim 1, wherein the step of generating the pixel value of the target position in the output frame further comprises:
employing a pixel value of the first field or a pixel value of the third field as the pixel value of the target position in the output frame.
